(19) United States
(12) Patent Application Publication
(10) Pub. No.: US 2006/0216006 A1
(43) Pub. Date: Sep. 28, 2006

(54) Lens-fitted photo film unit

(76) Inventors: Takeshi Masuda, Kanagawa (JP); Mitsuhiro Moriya, Kanagawa (JP)

Correspondence Address: YOUNG & THOMPSON, 745 SOUTH 23RD STREET, 2ND FLOOR, ARLINGTON, VA, 22202, US

(21) Appl. No.: 11/390,194

(22) Filed: Mar. 28, 2006

(30) Foreign Application Priority Data
Mar. 28, 2005 (JP) 2005-092259

(51) Int. Cl. G03B 15/03

(52) U.S. Cl. 396/6; 396/179

(57) ABSTRACT

A lens-fitted photo film unit with a flash device is preloaded with a photo film having ISO sensitivity of 1600 or above. When a non-flash night view photography mode is selected by operating an operation member, an aperture stop device switches in a large aperture state and a shutter device switches to slow shutter speed, and the flash device is turned off. Owing to this, an appropriate exposure can be given to a subject whose exposure value is less than 8 at ISO 100, which enables to obtain pictures having high image quality in terms of describing the depth of the image, without use of the flashlight in dim places such as indoors. When a daylight photography mode is selected, it provides small aperture state/fast shutter speed/flash-off state. When a nighttime synch photography mode is selected, it provides large aperture state/slow shutter speed/flash-on state.

### BACKGROUND OF THE INVENTION

1. Field of the Invention

The present invention relates to a lens-fitted photo film unit having a plurality of photography modes.

2. Background Arts

A variety of lens-fitted photo film units with a preloaded photo film have been on the market. Japanese Patent Laid-Open Publication Number 2000-162741 discloses one of such lens-fitted photo film units preloaded with a high-speed photo film and capable of changing shutter speed and an aperture stop for the purpose of improving descriptiveness of a background when taking pictures in a dark place such as indoors or in the nighttime. This lens-fitted photo film unit takes a main subject along with the background in the photo film with ensuring sufficient brightness of the main subject by emitting flashlight when taking pictures indoors or in the nighttime.

“Night & Day” (trade name), manufactured and sold by the applicant of the present invention, is known as the lens-fitted photo film unit of mode changeover type having a high-speed photo film. The “Night & Day” has three photography modes: a daylight photography mode (without emission of flashlight), a daylight synch photography mode (with emission of flashlight) and a night view synch photography mode (with emission of flashlight). The daylight photography mode and the daylight synch photography mode are suitable for photographing in bright places like outdoors in the daytime. The night view sync photography mode is suitable for photographing the main subject such as people with the flashlight while obtaining the background with an appropriate density against a night view or a dark room background.

The “Night & Day” is set in a fast shutter speed/small aperture state in the daylight photography mode and the daylight synch photography mode, while it is set in a slow shutter speed/large aperture state in the night view synch photography mode. Specifically, when the photo film of ISO 1600 is used, the shutter speed is 1/120 sec and an f-number is f14 in the daylight photography mode and the daylight synch photography mode, while the shutter speed is 1/45 sec and the f-number is f6.2 in the night view synch photography mode. In order to achieve an appropriate exposure, an exposure value at ISO 100 is 10.5 in the daylight photography mode and the daylight sync photography mode, while it is 6.8 in the night view sync photography mode.

As one technique of the photographing, there is a way to take pictures without using the flashlight in order to describe the atmosphere of the shooting scene more vividly. Pictures taken with the flashlight are relatively plain and it is difficult to make a drastic change in their impressions, but they can capture the main subject clearly. On the other hand, pictures taken without the flashlight can describe the depth of the image by capturing available light in the shooting scene, but the main subject sometimes appears too dark. Both of the photographing methods, that is, the photographing with or without the flashlight, have merits and demerits therefore it is preferable that a user can select one of them, depending on his/her intention.

However, the conventional lens-fitted photo film units are designed to always require the use of the flashlight when photographing indoors or in the nighttime. Therefore, when such lens-fitted photo film units are used to photograph indoors or in the nighttime without the flashlight, it is difficult to obtain pictures with high image quality.

### SUMMARY OF THE INVENTION

An object of the present invention is to provide a lens-fitted photo film unit capable of obtaining pictures with high image quality when photographing indoors or against a night view without flashlight.

In order to achieve the above and other objects, the lens-fitted photo film unit of the present invention includes a photo film, a flash device and an exposure control device. The photo film has ISO sensitivity of 1600 or above. The flash device has a flash-on state and a flash-off state. The exposure control device controls an exposure of the photo film. In the flash-off state, an appropriate exposure can be given to a subject whose exposure value is less than 8 at ISO 100. One of the flash-on state and the flash-off state is selected by a mode changeover member. The exposure control device includes a shutter device and an aperture stop device.

It is preferable that the photo film has ISO sensitivity of 3200 or above. When FN is an f-number in the flash-off state, the following condition is satisfied: 2.8≦FN≦8.

In a preferable embodiment of the present invention, the lens-fitted photo film unit includes the photo film having ISO sensitivity of 1600 or above, the flash device, the aperture stop device and the mode changeover device. The flash device is switchable between the flash-on state and the flash-off state. The aperture stop device is switchable between a small aperture state and a large aperture state. The mode switchover member selects one of first, second and third photography modes. The first photography mode provides the flash-off state/small aperture state. The second photography mode provides the flash-off state/large aperture state. The third photography mode provides the flash-on state/large aperture state.

In another preferable embodiment of the present invention, the lens-fitted photo film unit includes the photo film having ISO sensitivity of 1600 or above, the flash device, the aperture stop device, the shutter device and the mode changeover device. The shutter device is switchable between fast shutter speed and slow shutter speed. The mode switchover member selects one of first, second and third photography modes. The first photography mode provides the flash-off state/small aperture state/fast shutter speed. The second photography mode provides the flash-off state/large aperture state/slow shutter speed. The third photography mode provides the flash-on state/large aperture state/slow shutter speed.

The aperture stop device is provided with an aperture stop changeover plate having a small aperture formed therein. The aperture stop changeover plate is inserted in and retracted out of a photographing optical path in cooperation with the mode changeover member. The aperture stop device is switched to the small aperture state when the aperture stop changeover plate is inserted in the photographing optical path. The aperture stop device is switched to the large aperture state when the aperture stop changeover plate is retracted out of the photographing optical path.

When FL is an f-number in the large aperture state and FS is an f-number in the small aperture state, the following conditions are satisfied: 2.8≦FL≦8, 13≦FS.

The shutter device is provided with a shutter blade and a shutter speed changeover member that is inserted in and retracted out of a moving path of the shutter blade in cooperation with the mode changeover member. The shutter device is switched to the fast shutter speed when the shutter speed changeover member is inserted in the moving path of the shatter blade to limit the moving range. The shutter device is switched to the slow shutter speed when the shutter speed changeover member is retracted out of the moving path.

When S1 is the slow shutter speed and S2 is the fast shutter speed, the following conditions are satisfied: 1/30 sec≧S1≧ 1/60 sec, 1/80 sec≧S2.

In yet another preferable embodiment of the present invention, the mode changeover member selects one of first, second and third photography modes. The first photography mode provides the flash-off state/small aperture state in which the f-number (FS) is 13≦FS/fast shutter speed (S2) at 1/80 sec≧S2. The second photography mode provides the flash-off state/large aperture state in which the f-number (FL) is FL≦8/slow shutter speed (S1) at S1≧ 1/60 sec. The third photography mode provides the flash-on state/large aperture state in which the f-number (FL) is FL≦8/slow shutter speed (S1) at S1≧ 1/60 sec.

In still another preferable embodiment of the present invention, the mode changeover member selects one of first, second and third photography modes. The first photography mode provides the flash-off state/small aperture state in which the f-number (FS) is 13≦FS/fast shutter speed (S2) at 1/80 sec≧S2. The second photography mode provides the flash-off state/large aperture state in which the f-number (FL) is FL≦8/slow shutter speed (S1) at S1≧ 1/60 sec. The third photography mode provides the flash-on state/small aperture state in which the f-number (FS) is 13≦FS/fast shutter speed (S2) at 1/80 sec≧S2.

The flash device does not generate the flashlight in the flash-off state, whereas it generates the flashlight in the flash-on state. When the flash device generates the flashlight in all of the first to third photography modes, a flash projector of the flash device is covered in the flash-off state, whereas it is exposed in the flash-on state.

According to the lens-fitted photo film unit of the present invention, the exposure value of less than 8 (at ISO 100), which is appropriate for the photographing indoors or against the night view, is obtained. Owing to this, it is possible to obtain pictures with high image quality when photographing indoors or against the night view without the flashlight.

### BRIEF DESCRIPTION OF THE DRAWINGS

One with ordinary skill in the art would easily understand the above-described objects and advantages of the present invention when the following detailed description is read with reference to the drawings attached hereto.

FIG. 1 is a perspective view illustrating a lens-fitted photo film unit in a daylight photography mode;

FIG. 2 is a perspective view illustrating the lens-fitted photo film unit in a non-flash night view photography mode;

FIG. 3 is a perspective view illustrating the lens-fitted photo film unit in a nighttime synch photography mode;

FIG. 4 is an exploded perspective view illustrating a composition of a unit body;

FIG. 5 is an exploded perspective view illustrating compositions of an aperture stop device and a shutter device;

FIG. 6 is an explanatory view illustrating a stop lever in a fast shutter speed position;

FIG. 7 is an explanatory view illustrating the stop lever in a slow shutter speed position;

FIG. 8 is an explanatory view illustrating the movement of a shutter blade when the stop lever is in the fast shutter speed position;

FIG. 9 is an explanatory view illustrating the movement of the shutter blade when the stop lever is in the slow shutter speed position;

FIG. 10 is an explanatory view illustrating the aperture stop device and the shutter device in the daylight photography mode;

FIG. 11 is an explanatory view illustrating the aperture stop device and the shutter device in the non-flash night view photography mode;

FIG. 12 is an explanatory view illustrating the aperture stop device and the shutter device in the nighttime synch photography mode;

FIG. 13 is an explanatory view illustrating the aperture stop device and the shutter device in the daylight photography mode of second embodiment;

FIG. 14 is an explanatory view illustrating the aperture stop device and the shutter device in the nighttime synch photography mode of second embodiment; and

FIG. 15 is an explanatory view illustrating the aperture stop device and the shutter device in the non-flash night view photography mode of second embodiment.

### PREFERRED EMBODIMENTS OF THE INVENTION

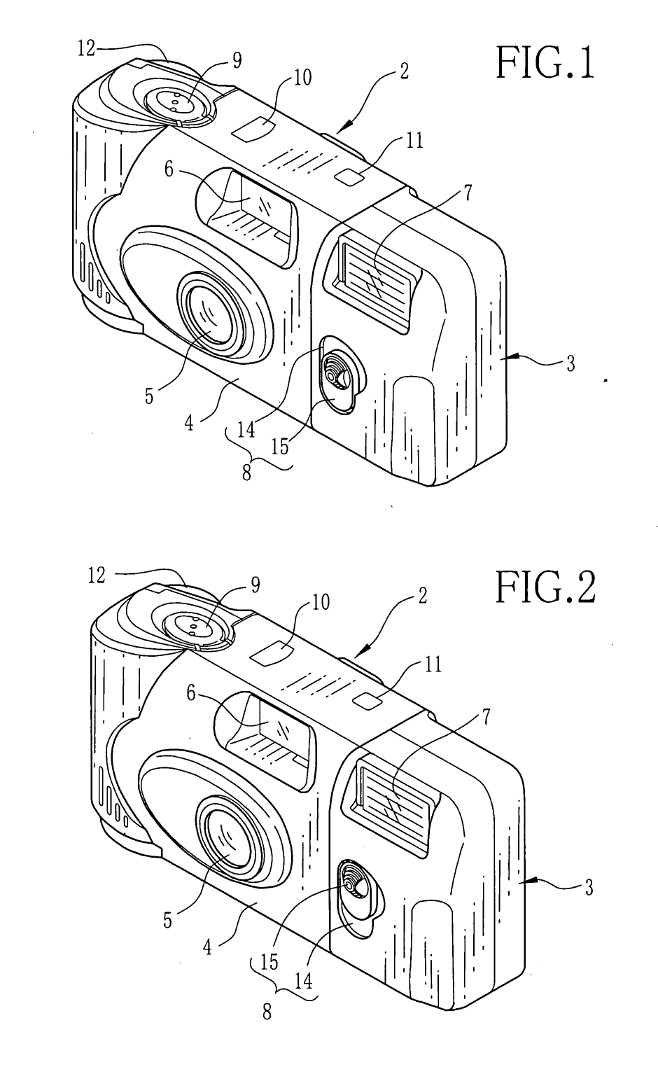

In FIGS. 1 to 3, a lens-fitted photo film unit 2 is constituted of a unit body 3 having a photographing mechanism incorporated therein and a label 4 attached around the unit body 3. The label 4 is provided with openings for exposing various parts of the unit body 3.

A front surface of the unit body 3 is provided with a taking lens 5, a viewfinder 6, a flash projector 7 and a photography mode selecting section 8. A top surface of the unit body 3 is provided with a shutter button 9, a counter display window 10 and a signal opening 11. A winding wheel 12 for winding up an exposed portion of a photo film is partially exposed at a rear surface of the unit body 3.

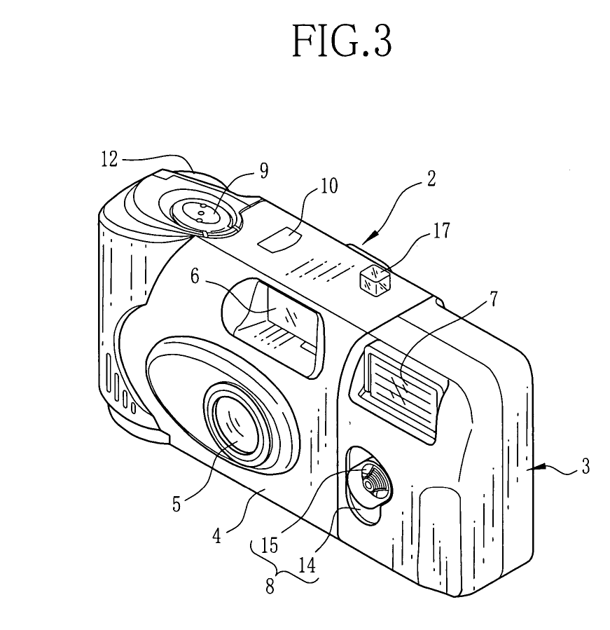

The photography mode selecting section 8 is constituted of a concave portion 14 and an operation member 15. The concave portion 14 is formed in the front surface of the unit body 3. The operation member 15 having an ellipse shape is movable within the concave portion 14. The operation member 15 is moved among a first operating position at the bottom of the concave portion 14 (see FIG. 1), a second operating position at the top of the concave portion 14 (see FIG. 2) and a third operating position rotated clockwise from the second operating position (see FIG. 3).

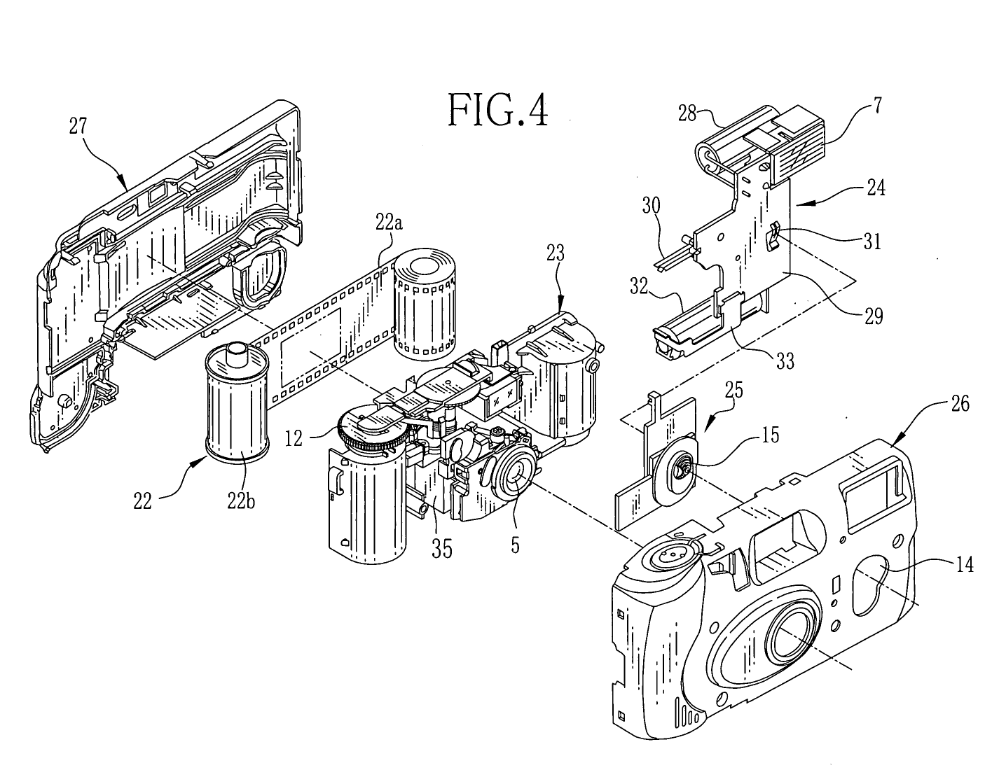

When the operation member 15 is in the first operating position, the lens-fitted photo film unit 2 is set in a daylight photography mode (first photography mode) that provides a flash-off state/small aperture state/fast shutter speed. When the operation member 15 is in the second operating position, the lens-fitted photo film unit 2 is set in a non-flash night view photography mode (second photography mode) that provides a flash-off state/large aperture state/slow shutter speed. When the operation member 15 is in the third operating position, the lens-fitted photo film unit 2 is set in a night time synch photography mode (third photography mode) that provides a flash-on state/large aperture state/slow shutter speed. In the nighttime synch photography mode, a signal member 17 protrudes from the top surface of the lens-fitted photo film unit 2 through the signal opening 11. The signal member 17 guides the light of a light emitting element, which emits the light when a flash device 24 (see FIG. 4) completes charging, to the outside of the unit body 3 so that a user is informed that the lens-fitted photo film unit 2 is ready for photographing.

As shown in FIG. 4, the unit body 3 is constituted of a body base 23 in which a photo film cartridge 22 of 135 type is loaded, the flash device 24 attached in front of the body base 23, a mode changeover mechanism 25 for changing the photography mode in response to the operation of the operation member 15, a front cover 26 and a rear cover 27 for covering the body base 23 from the front and the rear sides thereof.

The photo film cartridge 22 includes a photo film 22a and a cartridge shell 22b. The photo film 22a is preferably a high-speed photo film of ISO sensitivity 1600 or above, and more preferably of ISO 3200 or above. In the present embodiment, the photo film 22a has the ISO sensitivity of 3200.

The flash device 24 is constituted of a printed circuit board 29 and the flash projector 7. The printed circuit board 29 has a flash circuit with various electric components including a main capacitor 28 mounted thereon. The flash projector 7 includes a flash discharge tube, a reflector and a diffusion plate. The printed circuit board 29 is provided with a synch switch 30, a charging switch 31 and a battery contact plate 33. The synch switch 30 is turned on/off synchronously with opening/closing of a shutter blade. The charging switch 31 is turned on/off by the movement of the operation member 15. The battery contact plate 33 connects a battery 32 to the flash circuit.

When the charging switch 31 is turned on, the flash circuit charges the main capacitor 28 at high voltage. The flash circuit then discharges the main capacitor 28 via the flash discharge tube by turning on the synch switch 30, thereby emitting flashlight. When the charging switch 31 is turned off, the flashlight is not emitted even if the synch switch 30 is turned on, because the main capacitor 28 does not discharge at this time.

A light-shielding box 35 is provided at the center on the front side of the body base 23. Around the light-shielding box 35 is disposed a shutter charge mechanism, a film winding mechanism, a film winding stop mechanism, a film counting mechanism, a photographic optical system, a finder optical system, an aperture stop device and a shutter device that constitute an exposure control device, and the like.

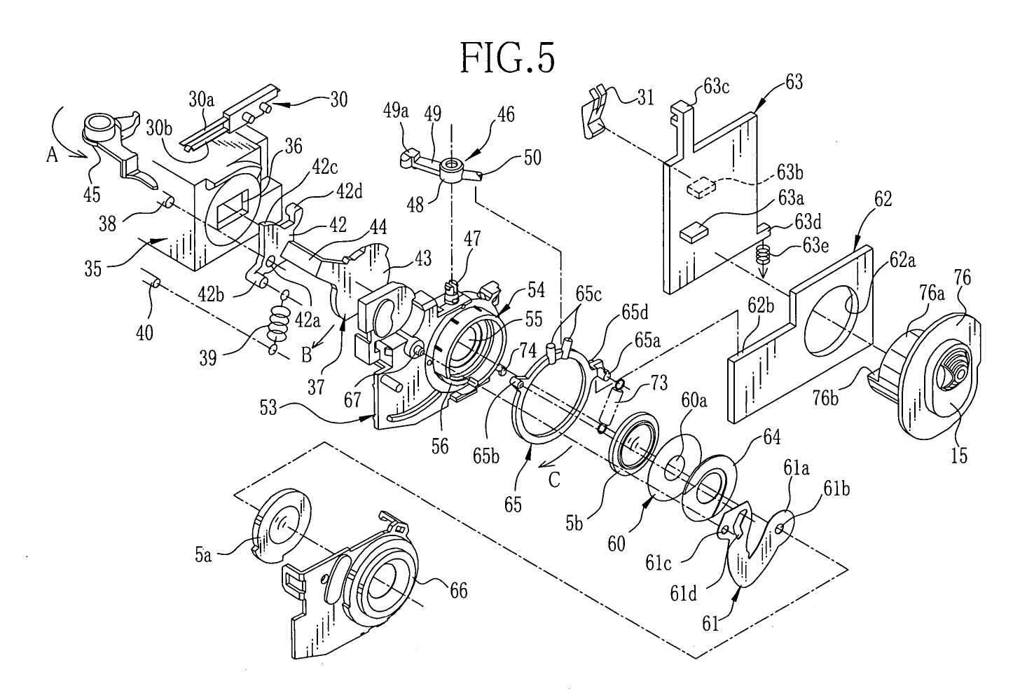

As shown in FIG. 5, a rectangular exposure opening 36 is formed in a front surface of the light-shielding box 35. A side of the light-shielding box is provided with a pin 38 for supporting a shutter blade 37 in a swingable manner and a pin 40 on which one end of a spring 39 is hanged.

The shutter device is constituted of the shutter blade 37, a shutter driving lever 45 and the shutter speed changeover mechanism. The shutter blade 37 includes a base portion 42, a blade portion 43 and a connecting portion 44. The base portion 42 has a hole 42a for receiving insertion of the pin 38. The blade portion 43 is disposed in front of the exposure opening 36 to open and close the exposure opening 36. The connecting portion 44 connects the base portion 42 and the blade portion 43. The base portion 42 is provided with a pin 42b, a projecting portion 42c and a synch projection 42d. The other end of the spring 39 is hanged on the pin 42b. The projecting portion 42c is kicked by the shutter driving lever 45. The shutter blade 37 is biased by the spring 39 to be kept in a position (close position) to close the exposure opening 36.

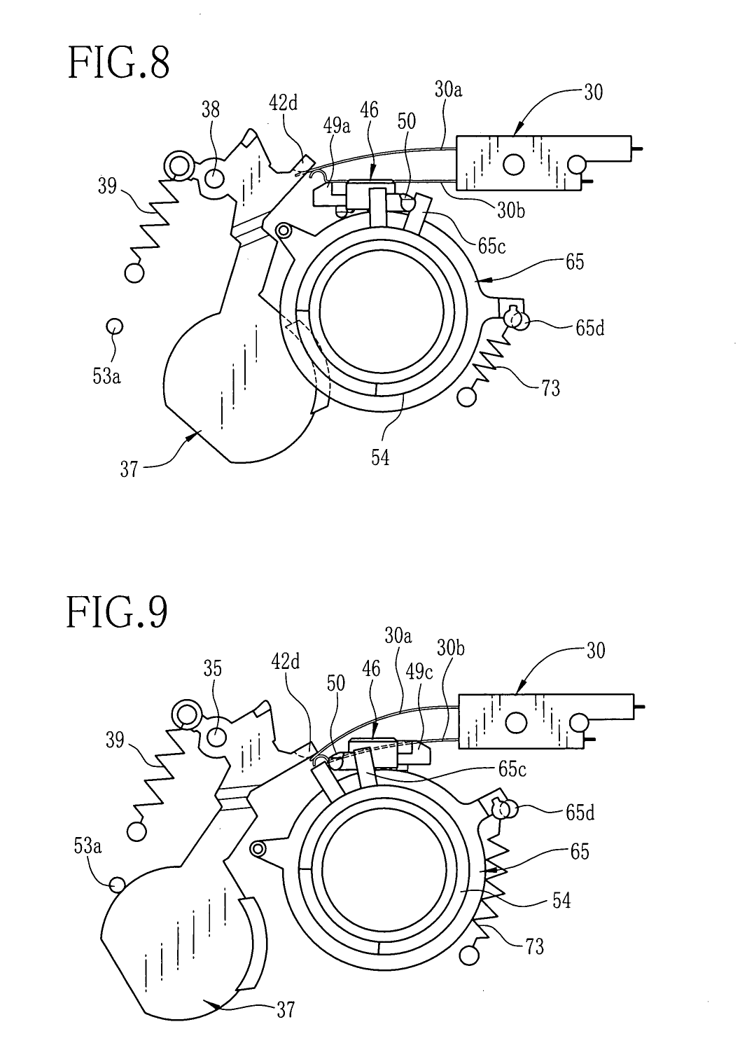

The shutter driving lever 45 is rotated in a direction opposite to the A direction (shown in FIG. 5) by the shutter charge mechanism to be set in a charging position. When the shutter driving lever 45 is released in response to the shutter button 9 being pressed down, it rotates in the A direction toward a charge release position and kicks the projecting portion 42c of the shutter blade 37 during the rotation. The shutter blade 37 being kicked by the shutter driving lever 45 rotates in the B direction (clockwise direction, shown in FIG. 5) against bias of the spring 39 to fully open the exposure opening 36. After that, the shutter blade 37 returns to the close position due to the bias of the spring 39. The shutter blade 37 is movable between a position (open position) to fully open the exposing opening 36 and a moving end position where the shutter blade 37 is in contact with a stopper pin 53a (see FIGS. 8 and 9) provided on an inner surface of a lens holder 53.

While rotating toward the moving end position, the synch projection 42d of the shutter blade 37 pushes down an upper metal contact 30a of the synch switch 30 to bring it into contact with a lower metal contact 30b. Thereby, the synch switch 30 is turned on.

The stop lever 46 constituting the shutter speed changeover mechanism is disposed on top of the lens holder 53, and supported by a pin 47 rotatably. The stop lever 46 is constituted of a boss 48 supported by the pin 47, and arms 49, 50 projecting from a side surface of the boss 48. A pad 49a is formed on an end of the arm 49.

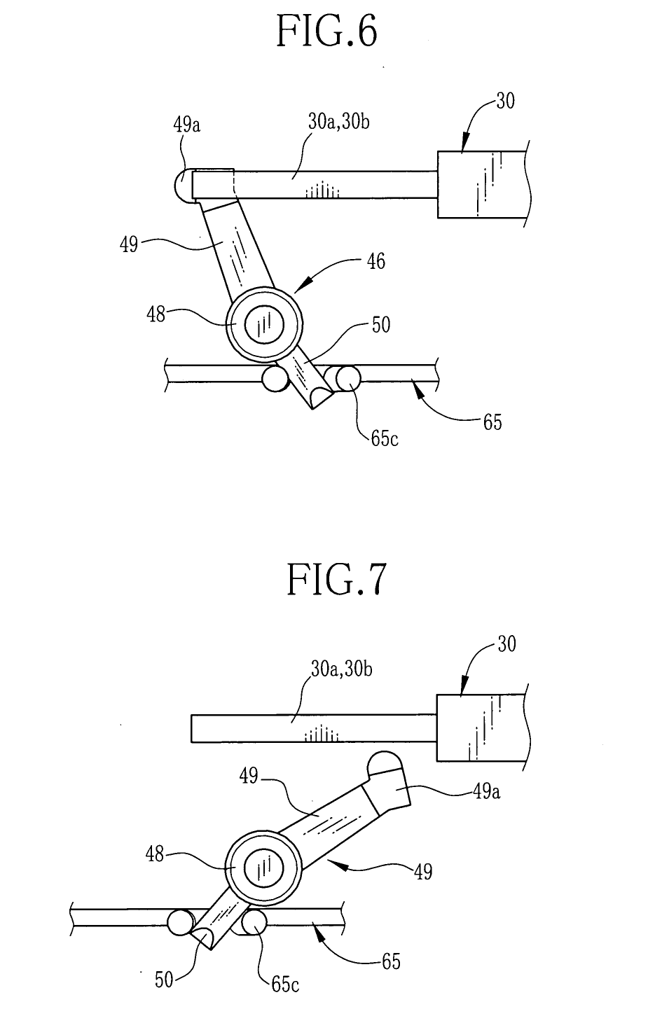

The stop lever 46 is rotated between a fast shutter speed position where the pad 49a is located under the lower metal contact 30b to be in contact therewith (see FIG. 6) and a slow shutter speed position where the pad 49a is separated from the lower metal contact 30b (see FIG. 7).

As shown in FIG. 8, when the shutter button 9 is pressed down while the stop lever 46 is in the fast shutter speed position, the upper metal contact 30a is pushed down by the synch projection 42d and contacts with the lower metal contact 30b. Thereby, the flashlight is emitted. Since the lower metal contact 30b contacts with the pad 49a at this time, the lower metal contact 30b is prevented from deformed resiliently. Owing to this, the rotation of the shutter blade 37 is stopped at the open position, before reaching the moving end position. The shutter blade 37 thus returns to the close position quickly, and this makes the shutter speed fast. The shutter speed in the fast shutter speed position is, for example 1/120 sec.

When the stop lever 46 is in the slow shutter speed position as shown in FIG. 9, the lower metal contact 30b is deformed resiliently because the pad 49a is separated therefrom. Owing to this, the shutter blade 37 rotates fully to the moving end position. The shutter blade 37 thus takes time to return to the close position, and this makes the shutter speed slow. The shutter speed in the slow shutter speed position is, for example 1/45 sec.

As shown in FIG. 5, the lens holder 53 is secured to the front side of the light-shielding box 35. The lens holder 53 has a lens barrel 54 formed at the center thereof. An opening (shutter opening) 55 is formed in the lens barrel 54. A cutout 56 is formed in a lateral wall of the lens barrel 54. The lens barrel 54 contains the taking lens 5 constituted of a first lens element 5a and a second lens element 5b. A fixed aperture stop plate 60, an aperture stop changeover plate 61 and a spacer 64 for ensuring an insertion space for the aperture stop changeover plate 61 are arranged between the first and second lens elements 5a and 5b. The fixed aperture stop plate 60 is a circular thin plate having a large aperture 60a formed at the center thereof. The spacer 64 has an opening whose diameter is larger than that of the large aperture 60a.

A lens retainer plate 66 is fixed to the front of the lens holder 53 to retain the taking lens 5 and other relevant elements in the lens barrel 54. A changeover ring 65 is also retained by the lens retainer plate 66.

One end portion of the aperture stop changeover plate 61 is a small aperture stop portion 61a of a size to close the large aperture 60a. A small aperture 61b is formed in the small aperture stop portion 61a. A hole 61c and an L-shaped slot 61d are formed on the other end portion of the aperture stop changeover plate 61. A pin 67 formed in the vicinity of the lens barrel 54 is inserted in the hole 61c and holds the aperture stop changeover plate 61 pivotably. The aperture stop changeover plate 61 rotates between an inserted position (small aperture position) where the small aperture 61b is disposed on a photographing optical path and a retracted position (large aperture position) where the small aperture stop portion 61a is retracted out of the lens barrel 54 through the cutout 56 to expose the large aperture 60a. When the aperture stop changeover plate 61 is in the small aperture position, an f-number is, for example f14 by the small aperture 61b. When the aperture stop changeover plate 61 is in the large aperture position, the f-number is, for example f5.6 by the large aperture 60a.

The changeover ring 65 is fitted to the outer periphery of the lens barrel 54 in a rotatable manner. The changeover ring 65 is provided with a spring hanger pin 65a, a link pin 65b, a pair of pins 65c and a follower pin 65d. The spring hanger pin 65a retains one end of a spring 73. The link pin 65b is inserted in the slot 61d of the aperture stop changeover plate 61. The arm 50 of the stop lever 46 is positioned between the pair of pins 65c. The follower pin 65d projects toward the rear side of the changeover ring 65.

A pin 74 projects from a lower portion of the front surface of the lens holder 54, and retains the other end of the spring 73, which biases the change over ring 65 in the C direction (clockwise direction, shown in FIG. 5). The changeover ring 65 is kept in a predetermined position by the aperture stop changeover plate 61.

The operation member 15 is integrally formed with a shielding plate 76 that prevents the inside of the unit body 3 from being exposed. A boss 76a having a step portion 76b is integrally formed with the shielding plate 76 on the rear surface thereof. Behind the operation member 15, an exposure changeover plate 62 and a flash changeover plate 63 are disposed. The exposure changeover plate 62 is slid up and down in response to the movement of the operation member 15 between the first operating position and the second operating position. The flash changeover plate 63 is slid up and down in response to the movement of the operation member 15 between the second operating position and the third operating position.

The exposure changeover plate 62 is in a substantially rectangular shape and has an opening 62a to which the boss 76a is inserted. The exposure changeover plate 62 also has a change over portion 62b that is formed by partially cutting out the upper portion thereof. The follower pin 65d of the changeover ring 65 is positioned within a moving range of the changeover portion 62b.

The flash changeover plate 63 is in a substantially rectangular shape and integrally formed with projections 63a, 63b and an engaging portion 63c. The projection 63a is formed on the front surface of the flash changeover plate 63 and faces the step portion 76b of the boss 76a. The projection 63b is formed on the rear surface of the flash changeover plate 63 and faces the charging switch 31 of the flash device 24. The engaging portion 63c moves the signal member 17 up and down. The flash changeover plate 63 is biased downward by a spring 63e hung on a spring hanger portion 63d projecting from the side of the flash changeover plate 63.

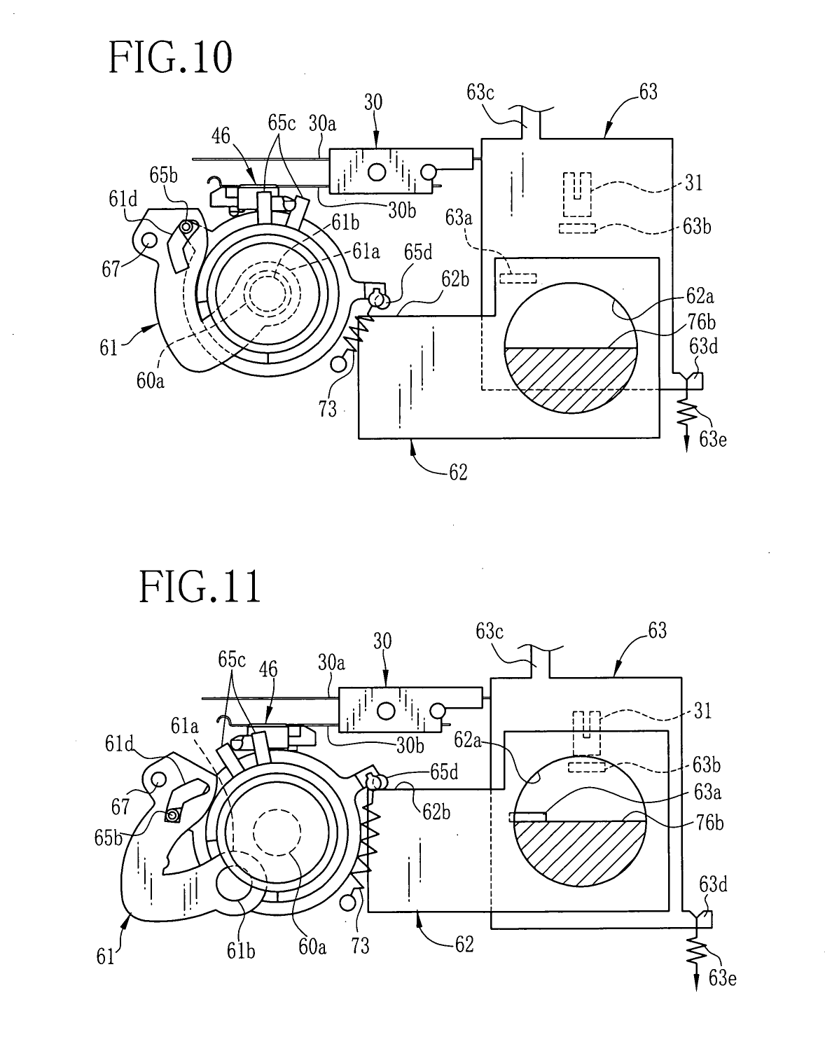

When the operation member 15 is in the first operating position to select the daylight photography mode as shown in FIG. 10, the changeover portion 62b does not contact with the follower pin 65d. Therefore, the changeover ring 65 is kept at an initial position by the aperture stop changeover plate 61.

When the changeover ring 65 is in the initial position, the small aperture stop portion 61a is inserted in a lens barrel 57 by the link pin 65b so that the small aperture 61b is overlaid on the large aperture 60a to establish the small aperture state. At this time, the pair of pins 65c keeps the stop lever 46 in the fast shutter speed position.

When the operation member 15 is slid to the second operating position to select the non-flash night view photography mode as shown in FIG. 11, the exposure changeover plate 62 is also slid up, since the opening 62a is engaged with the boss 76a. At this point, the changeover portion 62b pushes the follower pin 65d up and rotates the changeover ring 65 in the counterclockwise direction. By the rotation of the changeover ring 65, the aperture stop changeover plate 61 pressed by the link pin 65b is rotated in the clockwise direction. The small aperture stop portion 61a is retracted out of the photographing optical path to establish the large aperture state. At this time, the pair of pins 65c rotates the stop lever 46 and keeps it in the slow shutter speed position.

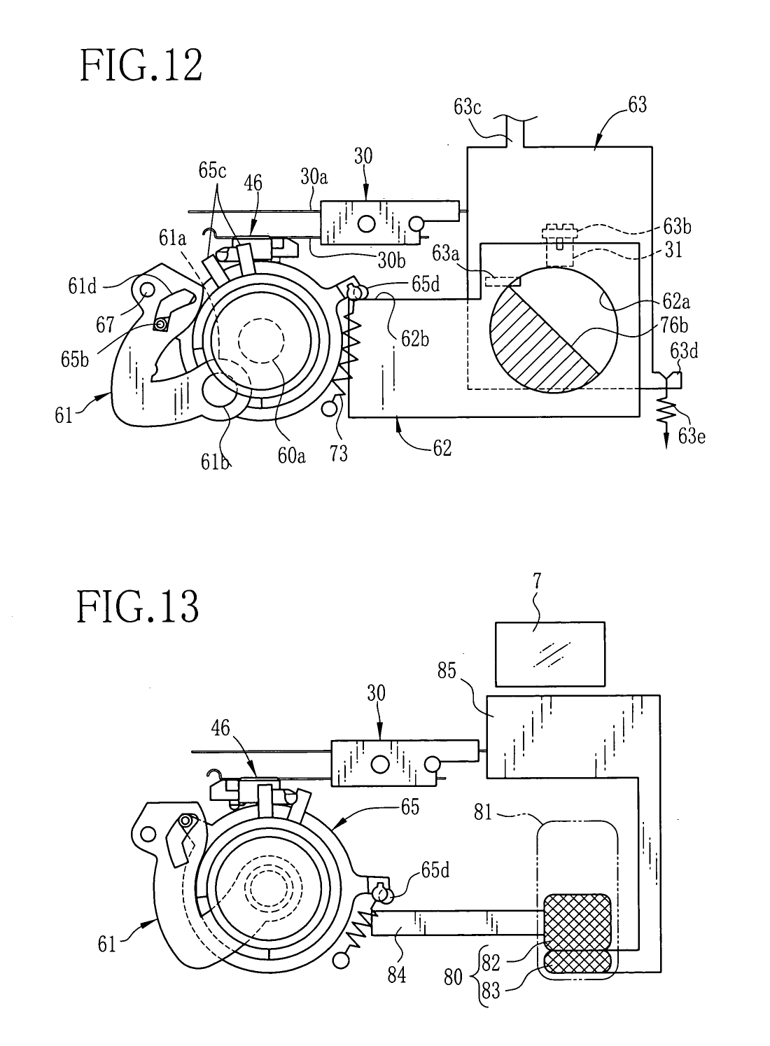

When the operation member 15 is rotated to the third operating position to select the nighttime synch photography mode as shown in FIG. 12, the projection 63a is pushed up by the step portion 76b to slide the flash changeover plate 63 up against the bias of the spring 63e. At this point, the projection 63b presses the charging switch 31 to turn the flash device 24 on. Since the rotation of the operation member 15 does not move the exposure changeover plate 62, the large aperture state/slow shutter speed is maintained. When the operation member 15 is rotated back from the third operating position to the second operating position, the flash changeover plate 63 slides down as biased by the spring 63e, and thus the flash device 24 is turned off.

The lens-fitted photo film unit 2 uses the photo film 22a of ISO 3200. In the daylight photography mode, the shutter speed is 1/120 sec, the f-number is f14 and the flashlight is not emitted. In the non-flash night view photography mode, the shutter speed is 1/45 sec, the f-number is f5.6. In the nighttime synch photography mode, the shutter speed is 1/45 sec, the f-number is f5.6 and the flashlight is emitted.

In the daylight photography mode, the appropriate exposure value at ISO 100 is 9.5. In the non-flash night view photography mode and the nighttime synch photography mode, the appropriate exposure value at ISO 100 is 5.5. Accordingly, the lens-fitted photo film unit 2 is capable of taking pictures under wide range of brightness, from dark scenes such as against the night view to ordinary scenes such as in the daylight, owing to exposure latitude of the photo film 22a. Moreover, it is possible to obtain pictures with high image quality even when photographing indoors or against the night view without the flashlight. Note that the appropriate exposure value at ISO 100 is calculated by the following formula:
EV=log₂(F²/T)−log₂(S/100)
where F is the f-number, T (sec) is the shutter speed, and S is the film sensitivity.

The following description explains an operation of the above embodiment. When daylight photography is performed in bright places like outdoors on a sunny day, the operation member 15 is slid downward within the concave portion 14 as shown in FIG. 1 to set in the first operating position, thereby selecting the daylight photography mode.

As shown in FIG. 10, when the operation member 15 is in the first operating position, the changeover ring 65 is rotated in the initial position by the bias of the spring 73. Thereby, the aperture stop changeover plate 61 is set in the small aperture position. In addition, the stop lever 46 is set in the fast shutter speed position, as shown in FIG. 6. At this time, the charging switch 31 of the flash device 24 is not pushed by the projection 63b and the signal member 17 does not protrude from the top surface of the unit body 3.

When the shutter button 9 is pressed down in the daylight photography mode, the shutter blade 37 starts rotating from the close position, but is stopped at the open position by the stop lever 46 via the synch switch 30. The shutter blade 37 thus returns to the close position quickly, and the shutter speed becomes fast. Since the aperture stop changeover plate 61 is on the photographing optical path, subject light entered the taking lens 5 is limited by the small aperture 61b. In addition, since the charging switch 31 is turned off, the flashlight is not emitted even if the synch switch 30 is turned on. Accordingly, the photography is performed with the shutter speed at 1/120 sec, the f-number at f14 and the flashlight off.

When photographing in dim places like indoors or photographing the night view without the flashlight, the operation member 15 is slid upward within the concave portion 14 as shown in FIG. 2 to set in the second operating position, thereby selecting the non-flash night view photography mode.

As shown in FIG. 11, when the operation member 15 is moved to the second operating position, the boss 76a slides the exposure changeover plate 62 up and the changeover portion 62b pushes the follower pin 65d up. The changeover ring 65 then rotates from the initial position against the bias of the spring 73. Thereby, the aperture stop changeover plate 61 rotates to the large aperture position. In addition, the stop lever 46 is set in the slow shutter speed position, as shown in FIG. 7.

In the non-flash night view photography mode, the shutter device is in the slow shutter speed at 1/45 sec. In addition, the subject light entered the taking lens 5 exposes the photo film 22a through the large aperture 60a. Therefore, light amount is limited by the large aperture 60a, that is, with the f-number at f5.6. Accordingly, it is possible to obtain pictures with high image quality in terms of describing the depth of the image and capturing available light in the shooting scene even with small amount of light like indoors or against the night view.

When photographing in dark places like outdoors in the nighttime with the flashlight, the operation member 15 is rotated in the clockwise direction within the concave portion 14 as shown in FIG. 3 to set in the third operating position, thereby selecting the nighttime synch photography mode.

As shown in FIG. 12, when the operation member 15 is rotated to the third operating position, the step portion 76b of the boss 76a pushes the projection 63a to slide the flash changeover plate 63 up. At this point, the projection 63b presses the charging switch 31 to turn the flash device 24 on. In addition, the engaging portion 63c moves the signal member 17 up to protrude from the top surface of the unit body 3.

In the night view photography mode, the shutter device is in the slow shutter speed at 1/45 sec, and the flashlight is emitted synchronously with the movement of the shutter blade 37. In addition, the subject light entered the taking lens 5 exposes the photo film 22a through the large aperture 60a. Therefore, the light amount is limited by the large aperture 60a, that is, with the f-number at f5.6.

As described above, the lens-fitted photo film unit 2 of the present invention is capable of photographing under wide range of brightness such as, in the bright places like outdoors on a sunny day, in the dim places like indoors or against the night view, in the dark places like outdoors in the nighttime and the like, by selecting each photography mode. In particular, the lens-fitted photo film unit 2 of the present invention is capable of photographing indoors or against the night view without the flashlight, and this configuration enables to make full use of various photographing techniques.

In the above embodiment, the flash device does not emit the flashlight in the non-flash night view photography mode. Instead of this configuration, it is also possible to cover the flash projector 7 while the flash device emits the flashlight. In the following description explains this second embodiment, and the components identical to those of the first embodiment are denoted by the same reference numerals, and descriptions thereof are omitted.

As shown in FIG. 13, an operating member 80 includes a first operating member 82 and a second operating member 83 that are slid up and down within a concave portion 81. A lever 84 is integrally formed with the first operating member 82. When the first operating member 82 is slid up, the lever 84 pushes the follower pin 65d up to rotate the changeover ring 65. A light-shielding plate 85 is integrally formed with the second operating member 83. When the second operating member 83 is slid up, the light-shielding plate 85 covers the front face of the flash projector 7. When the first and the second operating members 82, 83 are set at the bottom within the concave portion 81, the daylight photography mode is selected, thereby establishing the small aperture state/fast shutter speed/flash-off state.

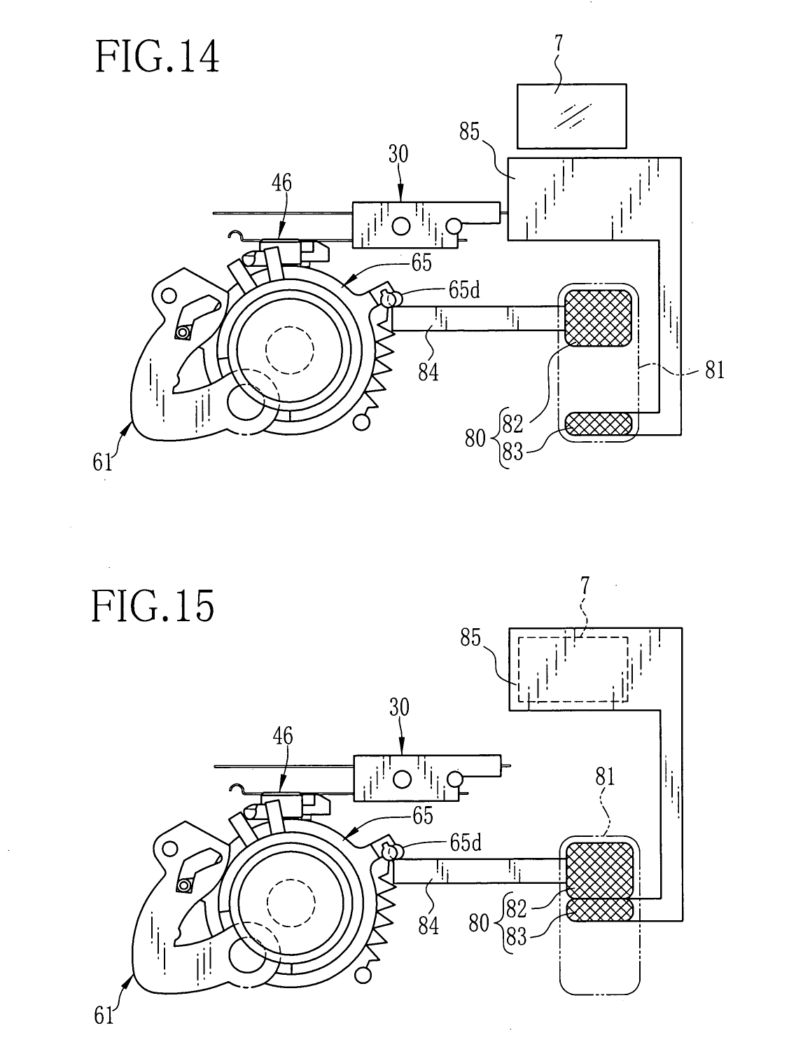

When the first operating member 82 is slid up as shown in FIG. 14, the lever 84 pushes the follower pin 65d up to rotate the changeover ring 65, and thereby the nighttime synch photography mode with the large aperture state/slow shutter speed/flash-on state is selected.

When the second operating member 83 is slid up as shown in FIG. 15, the light-shielding plate 85 covers the front face of the flash projector 7 so that the flashlight is not projected to the subject. Thereby, the non-flash night view photography mode with the large aperture state/slow shutter speed/flash-off state is selected. In this way, the non-flash night view photography mode can be provided to the lens-fitted photo film unit that has the nighttime synch photography mode, only by adding the light-shielding plate 85. It is thus possible to use common components for increasing various models of the film unit at low cost. In the non-flash night view photography mode, the user can confirm whether the photographing is performed or not by checking the flashlight slightly leaking from the light-shielding plate 85.

In the above embodiment, the nighttime synch photography mode with the large aperture state/slow shutter speed/flash-on state is provided. Instead of this mode, it is also possible to provide a daylight synch mode with the small aperture state/fast shutter speed/flash-on state.

The slow shutter speed (S1) is S1≧ 1/60 sec while the fast shutter speed (S2) is 1/80 sec≧S2. More preferably, the slow shutter speed (S1) is in the range of 1/30 sec≧S1≧ 1/60 sec while the fast shutter speed (S2) is 1/80 sec≧S2. The f-number (FS) is 13≦FS in the small aperture state while the f-number (FL) is FL≦8 in the large aperture state. More preferably, the f-number (FS) is 13≦FS in the small aperture state while the f-number (FL) is in the range of 2.8≦FL≦8 in the large aperture state.

Although the present invention has been described with respect to the preferred embodiments, the present invention is not to be limited to the above embodiments but, on the contrary, various modifications will be possible to those skilled in the art without departing from the scope of claims appended hereto.

What is claimed is:

1. A lens-fitted photo film unit comprising:
a preloaded unexposed photo film having ISO sensitivity of 1600 or above;
a mode changeover member for selecting one of a flash-off state and a flash-on state;
a flash device for emitting flashlight, said flash device not projecting said flashlight toward an subject in said flash-off state and projecting said flashlight toward said subject in said flash-on state; and
an exposure control device for controlling an exposure of said photo film, said exposure control device giving an appropriate exposure value of less than 8 at ISO sensitivity 100 in said flash-off state.

2. A lens-fitted photo film unit as claimed in claim 1, wherein said exposure control device gives said appropriate exposure value of 9.5 in said flash-on state, whereas said exposure control device gives said appropriate exposure value of 5.5 in said flash-off state.

3. A lens-fitted photo film unit as claimed in claim 1, wherein said photo film has ISO sensitivity of 3200 or above.

4. A lens-fitted photo film unit as claimed in claim 1, wherein the following condition is satisfied:
2.8≦FN≦8
where FN is an f-number in said flash-off state.

5. A lens-fitted photo film unit comprising:
a preloaded unexposed photo film having ISO sensitivity of 1600 or above;
a mode changeover member for selecting one of first, second and third photography modes;
a flash device for emitting flashlight, said flash device not projecting said flashlight toward an subject in said first and second photography modes and projecting said flashlight toward said subject in said third photography mode; and
an aperture stop device switchable between a small aperture state and a large aperture state, said aperture stop device being set in said small aperture state in said first photography mode and being set in said large aperture state in said second and third photography modes.

6. A lens-fitted photo film unit as claimed in claim 5, wherein said photo film has ISO sensitivity of 3200 or above.

7. A lens-fitted photo film unit as claimed in claim 5, wherein said flash device does not generate said flashlight in said first and second photography modes, whereas said flash device generates said flashlight in said third photography mode.

8. A lens-fitted photo film unit as claimed in claim 5, wherein said flash device generates said flashlight in all of said first to third photography modes, and a flash projector of said flash device is covered in said first and second photography modes, whereas said flash projector of said flash device is exposed in said third photography mode.

9. A lens-fitted photo film unit as claimed in claim 5, wherein said aperture stop device is provided with an aperture stop changeover plate having a small aperture formed therein, said aperture stop changeover plate being inserted in and retracted out of a photographing optical path in cooperation with said mode changeover member, said aperture stop device being set in said small aperture state when said aperture stop changeover plate is inserted in said photographing optical path and said aperture stop device being set in said large aperture state when said aperture stop changeover plate is retracted out of said photographing optical path.

10. A lens-fitted photo film unit as claimed in claim 9, wherein the following conditions are satisfied:
2.8≦FL≦5
13≦FS
where FL is an f-number in said large aperture state and FS is an f-number in said small aperture state.

11. A lens-fitted photo film unit as claimed in claim 5, further comprising:
a shutter device switchable between fast shutter speed and slow shutter speed, said shutter device being set in said fast shutter speed in said first photography mode and being set in said slow shutter speed in said second and third photography modes.

12. A lens-fitted photo film unit as claimed in claim 11, wherein said photo film has ISO sensitivity of 3200 or above.

13. A lens-fitted photo film unit as claimed in claim 11, wherein said flash device does not generate said flashlight in said first and second photography modes, whereas said flash device generates said flashlight in said third photography mode.

14. A lens-fitted photo film unit as claimed in claim 11, wherein said flash device generates said flashlight in all of said first to third photography modes, and a flash projector of said flash device is covered in said first and second photography modes, whereas said flash projector of said flash device is exposed in said third photography mode.

15. A lens-fitted photo film unit as claimed in claim 11, wherein said shutter device is provided with a swingable shutter blade and a shutter speed changeover member that is inserted in and retracted out of a moving path of said shutter blade in cooperation with said mode changeover member, said shutter device being set in said fast shutter speed when said shutter speed changeover member is inserted in said moving path of said shutter blade and said shutter device being set in said slow shutter speed when said shutter speed changeover member is retracted out of said moving path of said shutter blade.

16. A lens-fitted photo film unit as claimed in claim 15, wherein the following conditions are satisfied:
1/30sec≧S1≧ 1/60 sec
1/80 sec≧S2
where S1 is said slow shutter speed and S2 is said fast shutter speed.

17. A lens-fitted photo film unit as claimed in claim 11, wherein said aperture stop device is provided with an aperture stop changeover plate having a small aperture formed therein, said aperture stop changeover plate being inserted in and retracted out of a photographing optical path in cooperation with said mode changeover member, said aperture stop device being set in said small aperture state when said aperture stop changeover plate is inserted in said photographing optical path and said aperture stop device being set in said large aperture state when said aperture stop changeover plate is retracted out of said photographing optical path.

18. A lens-fitted photo film unit as claimed in claim 17, wherein the following conditions are satisfied:
2.8≦FL≦8
13≦FS
where FL is an f-number in said large aperture state and FS is an f-number in said small aperture state.

19. A lens-fitted photo film unit as claimed in claim 11, wherein the following conditions are satisfied:
FL≦8
13≦FS
S1≧ 1/60 sec
1/80 sec≧S2
where FL is an f-number in said large aperture state and FS is an f-number in said small aperture state, and S1 is said slow shutter speed and S2 is said fast shutter speed.

20. A lens-fitted photo film unit comprising:
a preloaded unexposed photo film having ISO sensitivity of 1600 or above;
a mode changeover member for selecting one of first, second and third photography modes;
a flash device for emitting flashlight, said flash device not projecting said flashlight toward an subject in said first and second photography modes and projecting said flashlight toward said subject in said third photography mode;
an aperture stop device switchable between a small aperture state and a large aperture state, said aperture stop device being set in said small aperture state in said first and third photography modes and being set in said large aperture state in said second photography mode; and
a shutter device switchable between fast shutter speed and slow shutter speed, said shutter device being set in said fast shutter speed in said first and third photography modes and being set in said slow shutter speed in said second photography mode.

21. A lens-fitted photo film unit as claimed in claim 20, wherein said flash device does not generate said flashlight in said first and second photography modes, whereas said flash device generates said flashlight in said third photography mode.

22. A lens-fitted photo film unit as claimed in claim 20, wherein said flash device generates said flashlight in all of said first to third photography modes, and a flash projector of said flash device is covered in said first and second photography modes, whereas said flash projector of said flash device is exposed in said third photography mode.

23. A lens-fitted photo film unit as claimed in claim 20, wherein the following conditions are satisfied:
FL≦8
13≦FS
S1≧ 1/60sec
1/80sec≧S2
where FL is an f-number in said large aperture state and FS is an f-number in said small aperture state, and S1 is said slow shutter speed and S2 is said fast shutter speed.
